(19) United States
(12) Patent Application Publication
(10) Pub. No.: US 2025/0291019 A1
(43) Pub. Date: Sep. 18, 2025

(54) NON-TRANSITORY COMPUTER READABLE MEDIUM STORING PROGRAM, INFORMATION PROCESSING SYSTEM, AND INFORMATION PROCESSING METHOD

(71) Applicant: FUJIFILM Business Innovation Corp., Tokyo (JP)

(72) Inventor: Masaru FUJII, Kanagawa (JP)

(73) Assignee: FUJIFILM Business Innovation Corp., Tokyo (JP)

(21) Appl. No.: 18/764,588

(22) Filed: Jul. 5, 2024

(30) Foreign Application Priority Data
Mar. 12, 2024 (JP) 2024-038431

(51) Int. Cl. G01S 5/00; H04N 1/00

(52) U.S. Cl. CPC G01S 5/0027; H04N 1/00307

(57) ABSTRACT

A non-transitory computer readable medium storing a program causes a computer to execute: estimating a position of an information device based on position information output by a portable device carried by a user at a time at which the user operates the information device.

### CROSS-REFERENCE TO RELATED APPLICATIONS

This application is based on and claims priority under 35 USC 119 from Japanese Patent Application No. 2024-038431 filed Mar. 12, 2024.

### BACKGROUND

### (i) Technical Field

The present disclosure relates to a non-transitory computer readable medium storing a program, an information processing system, and an information processing method.

### (ii) Related Art

For example, JP2020-144763A discloses a system including a plurality of client terminals and a reception service system that receives data from the plurality of client terminals, in which the reception service system includes a first reception unit that receives data as a target of a predetermined process, and a second reception unit that receives data that is not set as the target of the predetermined process.

### SUMMARY

Aspects of non-limiting embodiments of the present disclosure relate to a non-transitory computer readable medium storing a program, an information processing system, and an information processing method that estimate a position of an information device operated by a user at an installation location of the information device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable medium storing a program for causing a computer to execute: estimating a position of an information device based on position information output by a portable device carried by a user at a time at which the user operates the information device.

### BRIEF DESCRIPTION OF THE DRAWINGS

Exemplary embodiment(s) of the present invention will be described in detail based on the following figures, wherein:

FIG. 1 is a diagram showing an information processing system according to an exemplary embodiment of the present disclosure;

FIG. 2 is a diagram showing a configuration of a cloud server according to the exemplary embodiment of the present disclosure;

FIG. 3 is a diagram showing a procedure of associating a specific facility and an information device according to the exemplary embodiment of the present disclosure, and is a diagram showing an example of positions of the specific facility and the information device;

FIG. 4 is a diagram showing MFP operation history data according to the exemplary embodiment of the present disclosure;

FIG. 5 is a diagram showing movement history data according to the exemplary embodiment of the present disclosure;

FIG. 6 is a diagram showing use history data of the specific facility according to the exemplary embodiment of the present disclosure;

FIG. 7 is a flowchart showing a procedure of estimating a position of a user who operates the information device according to the exemplary embodiment of the present disclosure;

FIG. 8 is a diagram showing a position information list table of the information device according to the exemplary embodiment of the present disclosure; and

FIG. 9 is a flowchart showing a procedure of estimating the position of the information device according to the exemplary embodiment of the present disclosure.

### DETAILED DESCRIPTION

Hereinafter, an example of an exemplary embodiment of the present disclosure will be described with reference to the drawings. The identical reference numerals are given to the identical or equivalent components and parts in each drawing. In addition, the dimensional ratios in the drawings are exaggerated for convenience of description and may differ from the actual ratios.

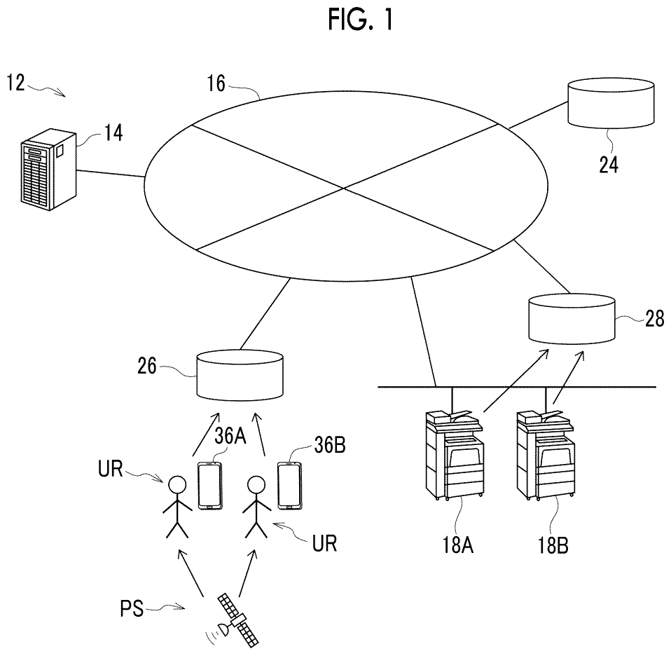

In the following description and drawings, the reference numerals indicated by adding one alphabet character to the numeral indicate that the identical reference numerals correspond to the same components, and the reference numerals are distinguished from each other. For example, in FIG. 1, “18A” and “18B” indicate the same components as that indicated by “18”. Therefore, in order to distinguish the components indicated by adding one alphabet character from the equivalent component, the name of the component may be added with “first”, “second”, and the like. In addition, in other words, a plurality of components may correspond to the reference numerals indicated by adding one alphabet character.

In addition, in the following description, “user” refers to a person who uses the information processing system according to the present exemplary embodiment in any manner without being limited to a specific person.

### Exemplary Embodiment

### Configuration

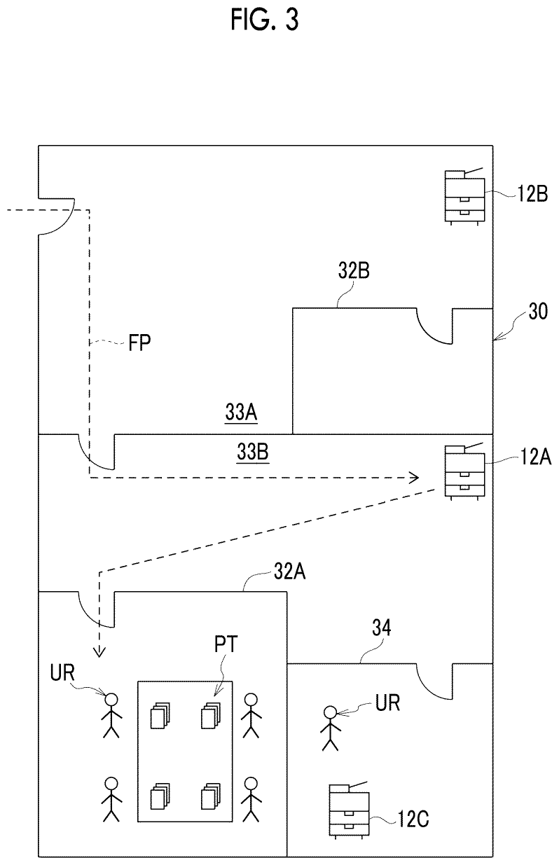

FIG. 1 is a diagram showing a configuration of an information processing system 12 according to the present exemplary embodiment. The information processing system 12 is connected to various information devices via the Internet 16 by a cloud server 14. More specifically, in the information processing system 12, position information PI of a user UR who holds a portable device 36 is collected. In addition, as shown in FIG. 1, the information processing system 12 is also connected to a use history recording unit 24, an operation history recording unit 28, and a movement history recording unit 26 via the Internet 16. In addition, FIG. 3 is a diagram showing an example of positions of a specific facility and the information device according to the present exemplary embodiment.

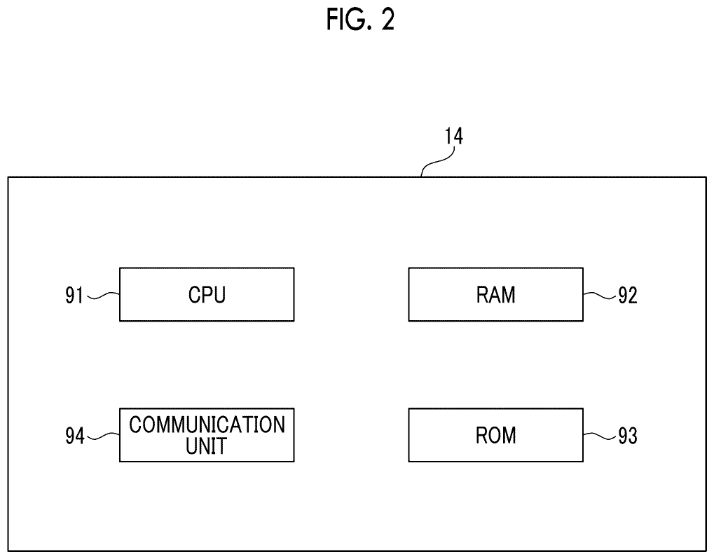

FIG. 2 is a block diagram showing a main configuration of the cloud server 14 according to the present exemplary embodiment. The cloud server 14 basically has a similar configuration to a configuration of a general computer.

The cloud server 14 includes a central processing unit (CPU) 91, a read only memory (ROM) 93, a random access memory (RAM) 92, a communication unit 94, and the like.

The CPU 91 is a device that controls the entire operation of the cloud server 14 and is an example of a “processor” according to the present exemplary embodiment. The ROM 93 stores various control programs, various parameters, and the like in advance. The RAM 92 is used as a work area at the time at which the CPU 91 executes various programs. The communication unit 94 is connected to the Internet 16 (see FIG. 1), and transmits and receives various types of data to and from other devices, such as the movement history recording unit 26, the operation history recording unit 28, the use history recording unit 24, and an MFP 18, which are connected to the Internet 16. The units of the cloud server 14 are connected to each other by a bus (not shown).

The cloud server 14 executes processes in accordance with the content of the program by the CPU 91 accessing the ROM 93 and the RAM 92. In addition, the cloud server 14 controls transmission and reception of communication data via the communication unit 94 by the CPU 91. The cloud server 14 may be connected to the Internet 16 in any manner as long as the cloud server 14 can communicate with the MFP 18.

The MFP 18 has a function of receiving a print job via the Internet 16 and forming an image on a manuscript, and a function of reading the image from the manuscript as image data and transmitting the image data to the cloud server 14. In the following description, the MFP 18 may have any configuration regardless of the type of MFP 18 as long as the MFP 18 can be connected to the cloud server 14 via the Internet 16.

In addition, here, as shown in FIG. 3, inside a building 30, a first room 33A, a second room 33B, a first conference room 32A, a second conference room 32B, and an executive office 34 are partitioned by walls. In addition, a plurality of MFPs 18 are disposed to be separated from each other. For example, as indicated by footprints FP, a user UR who uses the first conference room 32A performs printing of a document with first MFP 18A, and then enters the first conference room 32A with the printed matter PT obtained by the printing.

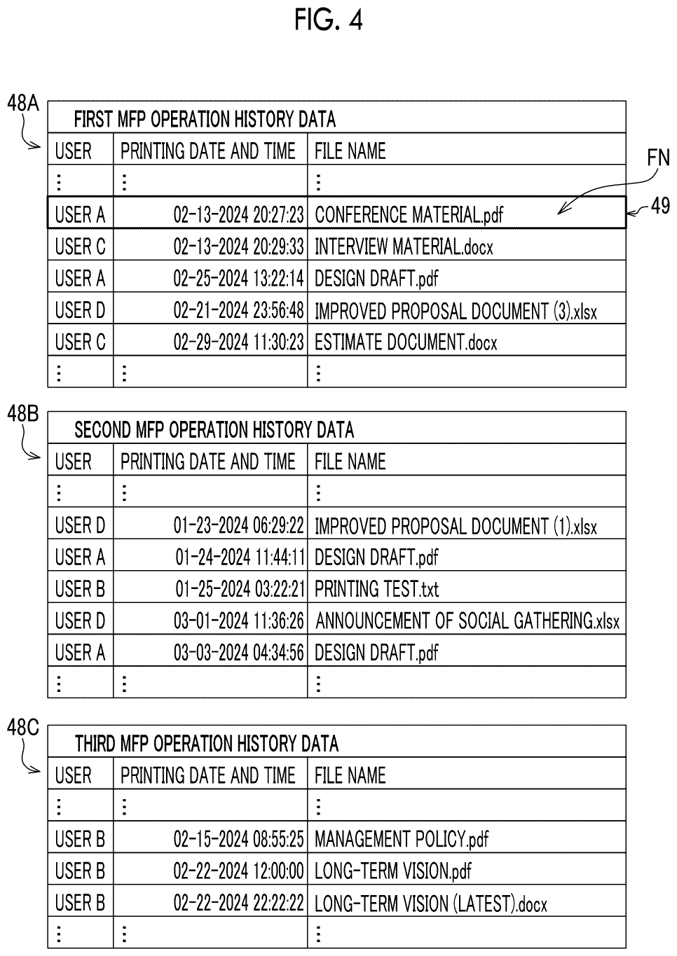

In the operation history recording unit 28, the operation history of the MFP 18 used by any person is recorded for each MFP 18. More specifically, as shown in FIG. 4, MFP operation history data 48 is recorded in the operation history recording unit 28 for each MFP 18. In addition, as an example, as shown in FIG. 4, “user” indicating the user UR who uses the MFP 18, “printing date and time” indicating the date and time at which the MFP 18 is used, and “file name” which is an example of identification information of printed data are recorded in the MFP operation history data 48. “Printing date and time” indicating the date and time at which the MFP 18 is used is an example of a “use time” in the present exemplary embodiment. In addition, as shown in FIG. 4, a record 49 added each time the MFP 18 is used is recorded in the MFP operation history data 48. That is, each record 49 is an example of an “operation history” according to the present exemplary embodiment.

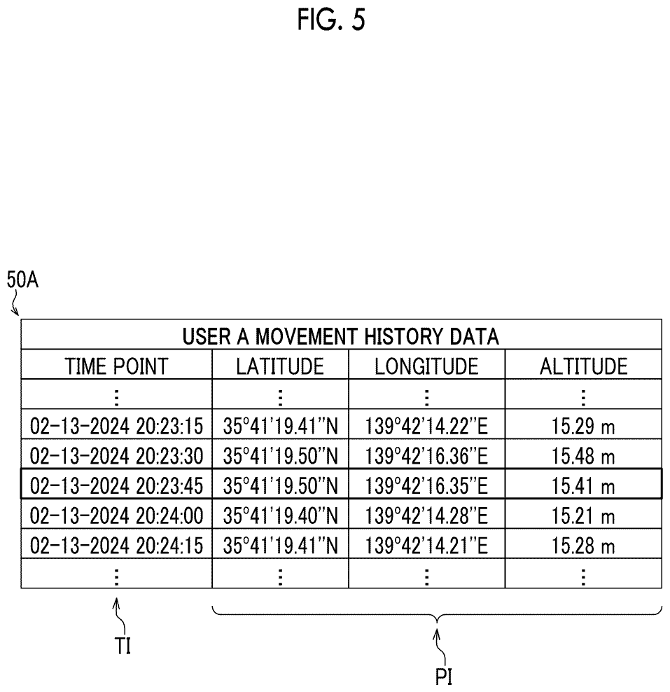

As shown in FIG. 1, the position information PI of the user UR who possess the portable device 36 and moves is recorded in the movement history recording unit 26. More specifically, as shown in FIG. 5, the position information PI of the portable device 36 is recorded in the movement history recording unit 26 as movement history data 50. As an example, coordinates of “latitude”, “longitude”, and “altitude” that are the position information PI of the portable device 36 and a “time point” that is a time at which the position information PI is acquired are recorded in the movement history data 50. That is, the “time point” in the movement history data 50 is an example of “time-point information” in the present exemplary embodiment. In addition, in other words, in the movement history data, the position information PI and the time-point information are associated with each other.

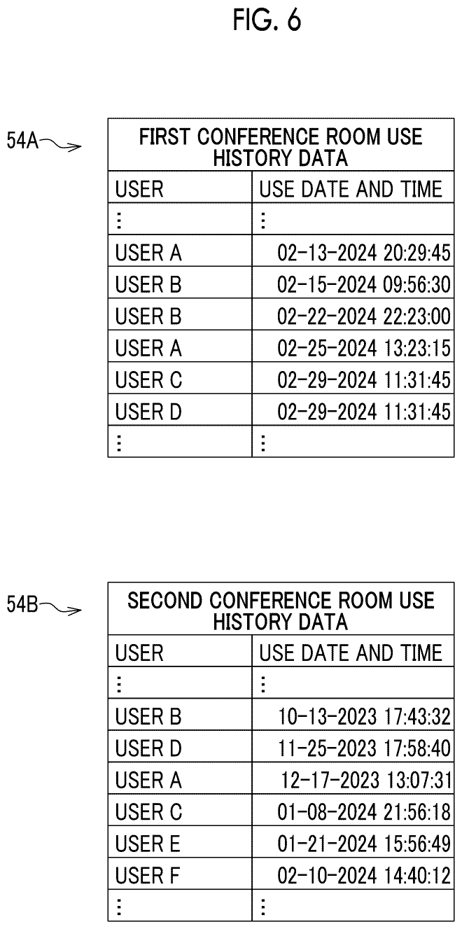

As shown in FIG. 6, the use history recording unit 24 records the use date and time of a person who has used the conference room 32. More specifically, as shown in FIG. 6, the use history for each conference room 32 is recorded in the use history recording unit 24 as the use history data 54. As an example, “user” who is a person using the conference room 32, and the date and time at which the conference room 32 is used are recorded in the use history data 54. As shown in FIG. 6, a record 49 added each time the conference room 32 is used is recorded in the use history data 54. A method of recording the use history data 54 is not particularly limited as long as a time point at which the user UR is in the conference room 32 is recorded in the use history data 54. As an example, the date and time at which the user UR releases an electronic lock of the conference room 32 in a case where the user UR uses the conference room 32 is recorded. In other words, the electronic lock creates the use history data 54 in which the user UR uses the conference room 32.

### Method of Estimating Installation Position of MFP

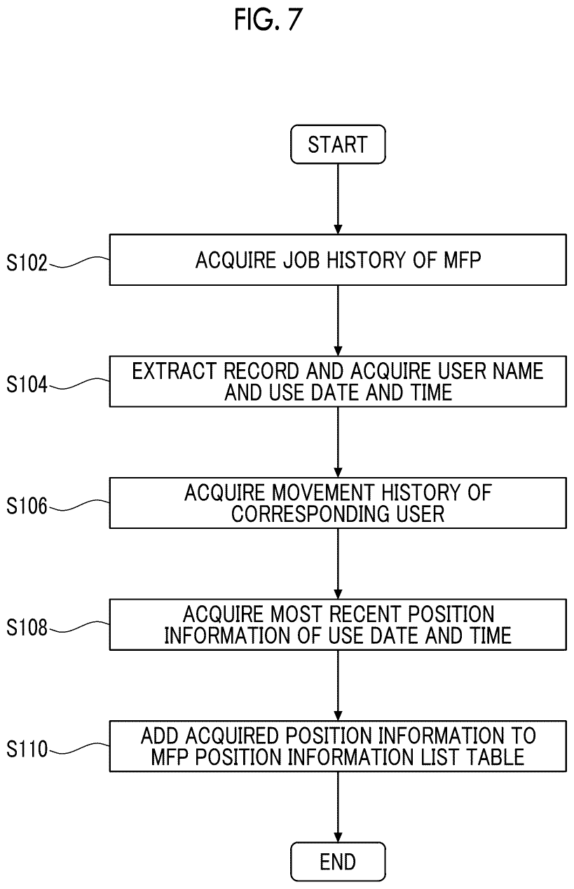

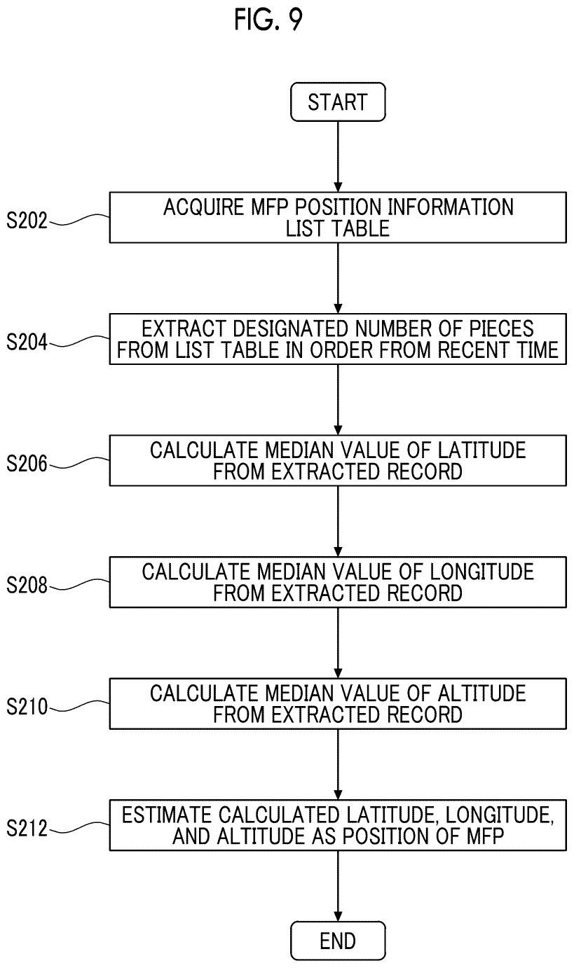

Next, a method in which the CPU 91 of the cloud server 14 in the present exemplary embodiment estimates an installation position of the MFP 18 will be described with reference to FIGS. 7 to 9. As shown in FIGS. 7 and 9, the cloud server 14 in the present exemplary embodiment executes a procedure of acquiring position information that can be estimated as the position information of the MFP and a procedure of estimating the installation position of the MFP from a plurality of pieces of the position information.

Procedure of Acquiring Position Information that Can be Estimated as Position Information of MFP

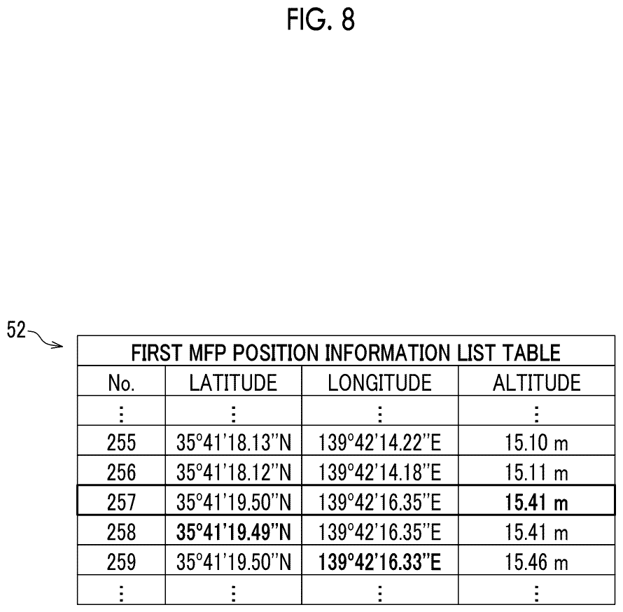

FIG. 7 shows a procedure of acquiring the position information that can be estimated as the position information of the MFP based on the MFP operation history data 48 of the MFP 18 and the movement history data 50 of the user UR, as a process executed by the CPU 91 according to the present exemplary embodiment. In addition, in FIG. 8, the estimated position information PI of the MFP 18 is recorded as an MFP position information list table 52 based on the movement history data 50. As shown in FIG. 8, the position information PI estimated as the actual position for each MFP 18 is recorded as a record in the MFP position information list table 52 of the MFP 18. In addition, the MFP position information list table 52 of the MFP 18 is recorded for each MFP 18. Here, as an example, a procedure of generating a record (record of No. 257) surrounded by a thick frame in FIG. 8 will be described.

First, in Step S102, the CPU 91 acquires a job history of the MFP 18. More specifically, the CPU 91 acquires MFP operation history data 48 of any MFP 18 shown in FIG. 4 from the operation history recording unit 28. Here, as shown in FIG. 4 as an example, the CPU 91 acquires first MFP operation history data 48A that is the operation history of the first MFP 18A. The CPU 91 transitions to Step S104.

Then, in Step S104, the CPU 91 extracts a record 49 included in the job history of the MFP 18 acquired in Step S102, and acquires the user name and the use date and time included in the record 49. Here, as shown in FIG. 4, the CPU 91 extracts the record 49 surrounded by a thick frame among records 49 included in the MFP operation history data 48, and acquires that the user name is “user A” and the printing date and time is “Feb. 13, 2024 20:27:23”. Then, the CPU 91 transitions to Step S106.

Next, in Step S106, the CPU 91 acquires a movement history of the user UR acquired in Step S104 from the movement history recording unit 26. More specifically, the CPU 91 acquires movement history data 50 corresponding to the user UR name acquired in Step S104, from the movement history recording unit 26. Here, as shown in FIG. 5, the CPU 91 acquires the movement history data 50 of “user A” from the movement history recording unit 26. Then, the CPU 91 transitions to Step S108.

Then, in Step S108, the CPU 91 acquires the most recent position information PI of the use date and time among the acquired pieces of movement history data 50. More specifically, the CPU 91 acquires the record 49 of the most recent time point of the use date and time acquired in Step S104 among the records 49 included in the movement history data 50. Here, as shown in FIG. 5, the CPU 91 extracts the record 49 surrounded by a thick frame in which the value of “Feb. 13, 2024 20:23:45” that is the most recent time point acquired in Step S104 is included in the movement history data 50. In addition, the CPU 91 acquires the latitude, the longitude, and the altitude, which are the position of the user A in the record 49, as the position information PI. Then, the CPU 91 transitions to Step S110.

Then, in Step S110, the CPU 91 adds the acquired position information PI of the user UR to the MFP position information list table 52 as shown in FIG. 8. More specifically, the CPU 91 adds the latitude, the longitude, and the altitude acquired in Step S108 to the MFP position information list table 52. Here, as shown in FIG. 8, the CPU 91 adds the position information PI of the user A acquired in Step S108 to the record surrounded by a thick frame in the MFP position information list table 52 of the first MFP 18A selected in Step S102.

In the above-described procedure, the CPU 91 acquires the position information PI that can be estimated as the position information PI of the MFP 18 and creates the MFP position information list table 52 of the MFP 18. The created MFP position information list table 52 is recorded in the ROM 93 of the cloud server 14 as an example.

The procedure of acquiring the position information that can be estimated as the position information of the MFP in the present disclosure is executed not only once but also for the number of records included in the MFP operation history data 48. In addition, the procedure of acquiring the position information that can be estimated as the position information of the MFP in the present disclosure is executed not only once but also for each MFP 18 for which the MFP operation history data 48 is included in the operation history recording unit 28.

### Procedure of Estimating Installation Position of MFP from Plurality of Pieces of Position Information

FIG. 9 shows the procedure of estimating the installation position of the MFP from the plurality of pieces of position information, as a process executed by the CPU 91 according to the present exemplary embodiment. Here, an example in which such a procedure is executed in a state where a plurality of records are recorded in the MFP position information list table 52 will be described.

First, the CPU 91 acquires the MFP position information list table 52 of the MFP 18 in Step S202. More specifically, the CPU 91 acquires the MFP position information list table 52 of the MFP 18 recorded in Step S110 from the ROM 93. Then, the CPU 91 transitions to Step S204.

Then, in Step S204, the CPU 91 extracts records of the designated number as a predetermined number from the MFP position information list table 52 of the MFP 18. More specifically, the CPU 91 extracts a plurality of records (records having a large value of No.) having a recent recording date and time in the MFP position information list table 52. Then, the CPU 91 transitions to Step S206.

Then, in Step S206, the CPU 91 calculates a median value of the latitude from the record extracted in Step S204. More specifically, the CPU 91 acquires the latitude for each record extracted in Step S204 and calculates the median value in a case where the acquired values of the latitude are arranged in order. For example, in a case in which the records from No. 255 to No. 259 in FIG. 8 are extracted, “35° 41′19.49″N” of No. 258 in FIG. 8 is calculated. Then, the CPU 91 transitions to Step S208.

Then, in Step S208, the CPU 91 calculates the median value of the longitude from the records extracted in Step S204. More specifically, the CPU 91 acquires the longitude for each record extracted in Step S204 and calculates the median value in a case where the acquired values of the longitude are arranged in order. For example, in a case in which the records from No. 255 to No. 259 in FIG. 8 are extracted, “139°42′16.33″E” of No. 259 in FIG. 8 is calculated. Then, the CPU 91 transitions to Step S210.

Then, in Step S210, the CPU 91 calculates the median value of the altitude from the record extracted in Step S204. More specifically, the CPU 91 acquires the altitude for each record extracted in Step S204 and calculates the median value in a case where the acquired values of the altitude are arranged in order. For example, in a case in which the records from No. 255 to No. 259 in FIG. 8 are extracted, “15.41 m” of No. 257 in FIG. 8 is calculated. Then, the CPU 91 transitions to Step S212.

Then, in Step S212, the CPU 91 estimates the latitude, the longitude, and the altitude calculated from Step S206 to Step S210, as the position of the MFP 18. More specifically, the CPU 91 estimates the position indicated by “35°41′19.50″N”, “139°42′16.33″E”, and “15.41 m” calculated in each of the above-described procedures, as the installation position of the first MFP 18A.

In this manner, the CPU 91 estimates the installation position of the MFP 18 from the plurality of pieces of position information PI. That is, the CPU 91 estimates the position of the first MFP 18A based on the median value in each direction (latitude, longitude, and altitude) obtained from the plurality of pieces of position information PI.

In the above-described procedure, although an example in which the CPU 91 estimates the installation position of the first MFP 18A has been described, the CPU 91 also estimates the installation positions of other MFPs 18 in the similar manner. In addition, the estimated installation position of the MFP 18 is recorded in the ROM 93 of the cloud server 14 as an example.

In the above-described procedure, the installation position of the MFP 18 has been described as an example of the information device, but the target for acquiring the position information PI is not limited to the MFP. That is, the position information PI of the conference room 32 may be estimated in the similar manner, based on the use history data 54 of the conference room 32 shown in FIG. 6 and the movement history data 50 shown in FIG. 5. In other words, in the conference room 32 shown in FIG. 3, a device (the electronic lock in the example of the above description) that creates the use history data 54 of the conference room 32 is also an example of the information device according to the present exemplary embodiment. In addition, the acquisition of the position information PI may be similarly performed for the conference room. That is, the target for acquiring the position information PI is not limited to the information device.

In addition, the time at which the CPU 91 executes the above-described method of estimating the installation position of the MFP 18 is not particularly limited, and examples include a case of executing the method periodically. In this case, for example, it is assumed that the CPU 91 estimates the installation position of the MFP 18 at a time of the same date every month.

With the information processing system 12 described above in the present exemplary embodiment, it is possible to obtain the following actions and effects.

### Action and Effect

The program according to this aspect causes the CPU 91 to estimate the position of the MFP 18 based on the position information PI output by the portable device 36 of the user UR who has operated the MFP 18. Therefore, with the program according to this aspect, it is possible to estimate the position of the MFP 18 operated by the user UR at the installation location of the MFP 18.

In addition, with the program according to this aspect, the CPU 91 is caused to estimate the position of the MFP 18 based on the position information PI output by the portable device 36 of the user UR who has operated the MFP 18. Therefore, with the program according to this aspect, it is possible to estimate the position of the MFP 18 that does not have a function of acquiring the position information PI, such as a GPS.

In addition, the program according to this aspect causes the CPU 91 to estimate the position of the MFP 18 based on the position information PI acquired from the movement history data 50 of the user UR who has operated the MFP 18. Therefore, with the program according to this aspect, it is possible to estimate the position of the MFP 18 operated by the user UR at the installation location of the MFP 18.

In addition, the program according to this aspect causes the CPU 91 to estimate the position of the MFP 18 based on the position information PI acquired from a plurality of records 49. Therefore, with the program according to this aspect, it is possible to suppress a deviation of the estimated position of the MFP 18 as compared with a case in which the position of the MFP 18 is estimated based on one piece of the position information PI.

In addition, the program according to this aspect causes the CPU 91 to estimate the position of the MFP 18 based on the median value in each of the directions obtained from a plurality of pieces of position information PI. Therefore, with the program according to this aspect, it is possible to suppress the deviation of the estimated position of the MFP 18 as compared with a case in which the position of the MFP 18 is estimated based on the average value of the plurality of pieces of the position information PI.

In addition, the program according to this aspect causes the CPU 91 to estimate the position of the MFP 18 based on a predetermined number of records 49 in order from the recent record 49 among the plurality of records 49. Therefore, even in a case in which the position of the MFP 18 is changed, it is easy to estimate the position based on the position information PI of the MFP 18 after the change. Thus, with the program according to this aspect, it is possible to suppress the deviation of the estimated position of the MFP 18 as compared with a case in which the position of the MFP 18 is estimated by using all the records 49.

In addition, with the program according to this aspect, the CPU 91 is caused to acquire the MFP operation history data 48 from the operation history recording unit 28 connected to the Internet 16. Therefore, with the program according to this aspect, it is possible to estimate the position of the MFP 18 connected via the Internet 16.

In addition, with the program according to this aspect, in a case where the connection with the MFP 18 via the Internet 16 is established, the position information PI of the MFP 18 is acquired. Therefore, with the program according to this aspect, in a case where the MFP 18 is added to the Internet 16, it is possible to estimate the position information PI of the MFP 18.

In addition, the information processing system 12 according to this aspect estimates the position of the MFP 18 based on the position information PI output by the portable device 36. Therefore, with the information processing system 12 according to this aspect, it is possible to estimate the position of the MFP 18 operated by the user UR at the installation location of the MFP 18.

### First Modification Example

In the above description, the CPU 91 periodically estimates the installation position of the MFP 18, but the operation of the CPU 91 in the present exemplary embodiment is not limited to this. For example, the CPU 91 may perform the estimation at a time at which it is determined that the MFP 18 is added to the network.

More specifically, the CPU 91 estimates the installation position of the MFP 18 at a time at which it is determined that a connection of a new MFP 18 with the network is established as an example. In addition, as an example, it is assumed that the CPU 91 estimates the installation position of the MFP 18 at a time at which it is determined that the MFP 18 is disconnected from the network once, and then the connection of the MFP 18 with the network is established again.

With the program according to the present modification example, by performing the estimation at such a time, the CPU 91 can estimate the position information of the MFP 18, for example, even in a case where the MFP 18 is added to the network or the installation position of the MFP 18 is changed.

### Second Modification Example

In addition, in the above description, although the installation position of the MFP 18 is estimated based on the MFP operation history data 48, the operation of the CPU 91 in the present exemplary embodiment is not limited to this. For example, the CPU 91 may determine the installation position of the MFP 18 based on the position information PI of the portable device 36 possessed by the user who has operated the MFP 18, at a time at which the CPU 91 determines that the user UR has operated the MFP 18 to execute a print job.

In addition, with the program according to the present modification example, the position information PI is acquired in a case where it is determined that the user has operated the information device. Therefore, with the program according to this aspect, it is possible to suppress the deviation of the estimated position of the information device as compared with a case where the position information PI is acquired based on the movement history data 50.

In the present modification example, the estimation is preferably performed in a case where the position information PI is changed, for example, at times before and after the user UR who operates the MFP 18 executes a print job. This is because, in a case where the position information PI is not changed at the times before and after the print job is executed, there is a possibility that the user UR does not carry the portable device 36 at a time of using the MFP 18.

### Other Modification Examples

In the above description, although the CPU 91 estimates the position of the MFP 18 as an example of the information device, the operation of the program according to the present exemplary embodiment is not limited to this. In a case where information similar to the operation history in the above description is recorded, the information device may include, for example, home appliances such as a microwave oven and a refrigerator, in addition to the MFP 18 and other devices that basically handle electronic data, such as a personal computer and a tablet terminal.

In addition, in the above description, although the CPU 91 estimates the position of the MFP 18 based on the plurality of records, the operation of the program according to the present exemplary embodiment is not limited to this. For example, the CPU 91 may estimate the position of the MFP 18 in the similar manner to the above description even in a case where there is only one record.

In addition, in the above description, although the CPU 91 estimates the position of the MFP 18 by combining the median values in the respective directions of the latitude, the longitude, and the altitude, but the operation of the program according to the present exemplary embodiment is not limited to this. The CPU 91 only needs to estimate the values of the coordinates for at least the latitude and the longitude and does not need to estimate the position for the altitude.

In addition, in the above description, although the CPU 91 estimates the position of the MFP 18 by combining the median values in the directions in the plurality of records, the operation of the program according to the present exemplary embodiment is not limited to this. For example, in a case where it is determined that the position of the MFP 18 is not likely to deviate from the values of the coordinates in the respective directions, the CPU 91 may estimate the position of the MFP 18 by obtaining other statistical values (for example, an average value) instead of combining the median values.

In addition, in the above description, although the CPU 91 estimates the position of the MFP 18 based on the number of records determined in order from the recent record, the operation of the program according to the present exemplary embodiment is not limited to this. For example, the CPU 91 may estimate the position of the MFP 18 based on all the records included in the MFP operation history data 48.

In addition, in the above description, although the CPU 91 acquires the MFP operation history data 48 from the operation history recording unit 28 connected to the Internet, the operation of the program according to the present exemplary embodiment is not limited to this. For example, the CPU 91 may acquire the MFP operation history data 48 from a recording unit (not shown) of a job history in the MFP 18, based on the job history executed by the MFP 18.

Even in these modification examples, it is possible to obtain the similar actions and effects to the above description.

Although the exemplary embodiments of the present disclosure have been described above with reference to the accompanying drawings, it is clear that anyone with ordinary knowledge in the field of the art to which the present disclosure belongs can come up with various modifications or applications within the scope of the technical ideas described in the claims, and it is understood that these also naturally belong to the technical scope of the present disclosure.

The aspects of the present disclosure will be further described below.

(((1)))

A program for causing a computer to execute:
estimating a position of an information device based on position information output by a portable device carried by a user at a time at which the user operates the information device.

(((2)))

The program according to (((1))),
wherein a time at which a specific user operates the information device is specified based on operation history data of the information device having an operation history in which information of an unspecified user and a time point at which the operation is performed are associated,
movement history data in which position information and time-point information are associated is acquired for the portable device carried by the specific user, and
the position information associated with the time-point information corresponding to the time at which the specific user operates the information device is used to estimate the position of the information device.

(((3)))

The program according to (((2))),
wherein a plurality of pieces of the position information are acquired from a plurality of operation histories, respectively, and the position of the information device is estimated based on the plurality of pieces of the position information.

(((4)))

The program according to (((3))),
wherein the position of the information device is estimated based on a median value in each of directions obtained from the plurality of pieces of the position information.

(((5)))

The program according to (((3))) or (((4))),
wherein the position of the information device is estimated based on a predetermined number of operation histories in order from a new operation history among the plurality of operation histories.

(((6)))

The program according to any one of (((2))) to (((5))),
wherein the operation history data is acquired from an operation history recording unit connected to a network.

(((7)))

The program according to (((6))),
wherein the position information is estimated in a case where a connection with the information device is established via the network.

(((8)))

The program according to (((1))),
wherein the position information is estimated in a case where determination that the user has operated the information device is made.

(((9)))

An information processing system comprising:
a processor configured to:
   estimate a position of an information device based on position information output by a portable device carried by a user at a time at which the user operates the information device.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program for causing a computer to execute:
estimating a position of an information device based on position information output by a portable device carried by a user at a time at which the user operates the information device.

2. The non-transitory computer readable medium storing a program according to claim 1,
wherein a time at which a specific user operates the information device is specified based on operation history data of the information device having an operation history in which information of an unspecified user and a time point at which the operation is performed are associated,
movement history data in which position information and time-point information are associated is acquired for the portable device carried by the specific user, and
the position information associated with the time-point information corresponding to the time at which the specific user operates the information device is used to estimate the position of the information device.

3. The non-transitory computer readable medium storing a program according to claim 2,
wherein a plurality of pieces of the position information are acquired from a plurality of operation histories, respectively, and the position of the information device is estimated based on the plurality of pieces of the position information.

4. The non-transitory computer readable medium storing a program according to claim 3,
wherein the position of the information device is estimated based on a median value in each of directions obtained from the plurality of pieces of the position information.

5. The non-transitory computer readable medium storing a program according to claim 3,
wherein the position of the information device is estimated based on a predetermined number of operation histories in order from a new operation history among the plurality of operation histories.

6. The non-transitory computer readable medium storing a program according to claim 2,
wherein the operation history data is acquired from an operation history recording unit connected to a network.

7. The non-transitory computer readable medium storing a program according to claim 3,
wherein the operation history data is acquired from an operation history recording unit connected to a network.

8. The non-transitory computer readable medium storing a program according to claim 4,
wherein the operation history data is acquired from an operation history recording unit connected to a network.

9. The non-transitory computer readable medium storing a program according to claim 5,
wherein the operation history data is acquired from an operation history recording unit connected to a network.

10. The non-transitory computer readable medium storing a program according to claim 6,
wherein the position information is estimated in a case where a connection with the information device is established via the network.

11. The non-transitory computer readable medium storing a program according to claim 7,
wherein the position information is estimated in a case where a connection with the information device is established via the network.

12. The non-transitory computer readable medium storing a program according to claim 8,
wherein the position information is estimated in a case where a connection with the information device is established via the network.

13. The non-transitory computer readable medium storing a program according to claim 9,
wherein the position information is estimated in a case where a connection with the information device is established via the network.

14. The non-transitory computer readable medium storing a program according to claim 1.
wherein the position information is estimated in a case where determination that the user has operated the information device is made.

15. An information processing system comprising:
a processor configured to:
estimate a position of an information device based on position information output by a portable device carried by a user at a time at which the user operates the information device.

16. An information processing method comprising:
estimating a position of an information device based on position information output by a portable device carried by a user at a time at which the user operates the information device.
